(19) United States
(12) Patent Application Publication
(10) Pub. No.: US 2022/0321176 A1
(43) Pub. Date: Oct. 6, 2022

(54) APPROACHES FOR BEAM MEASUREMENTS

(71) Applicant: Telefonaktiebolaget LM Ericsson (publ), Stockholm (SE)

(72) Inventors: Joao Vieira, Hjärup (SE); Eleftherios Karipidis, Stockholm (SE); Andres Reial, Lomma (SE); Krishna Chitti, Secunderabad Telangana (IN)

(21) Appl. No.: 17/634,971

(22) PCT Filed: Aug. 20, 2019
(86) PCT No.: PCT/EP2019/072214

§ 371 Date: Feb. 12, 2022

(51) Int. Cl. H04B 7/0408; H04B 7/0456; H04B 7/06

(52) U.S. Cl. CPC H04B 7/0408; H04B 7/0456; H04B 7/0617; H04B 7/0695

(57) ABSTRACT

A method is disclosed for a control node of a wireless communication system. The wireless communication system comprises two or more transmission arrangements and a receiver arrangement. Each transmission arrangement is associated with a respective set of available beams for beam measurements. The method comprises determining, for at least one transmission arrangement of the two or more transmission arrangements, a respective collection of linear combinations of available beams. At least one of the linear combinations comprises available beams from at least two sets of available beams associated with different transmission arrangements of the two or more transmission arrangements. The method also comprises causing transmission, by the transmission arrangements, of at least one of the linear combinations of available beams for beam measurements by the receiver arrangement. Corresponding apparatus, control node and computer program product are also disclosed.

### TECHNICAL FIELD

The present disclosure relates generally to the field of wireless communication. More particularly, it relates to approaches for measurements (e.g., beam evaluation and/or beam selection) in relation to beam forming applied in wireless communication.

### BACKGROUND

In wireless communication standards that rely on beamforming (e.g., fifth generation (5G), new radio (NR), IEEE 802.11ay, etc.), an important procedure for the base station (BS) is to find the best (or at least a good enough) beam towards each user equipment (UE) that it serves. This is usually achieved by some type of training transmissions (also referred to as beam training, beam sweeping, or beam sounding).

One way to implement such a procedure (which is used in IEEE 802.11ac, for example) is to let the BS transmit orthogonal beams, and let the UE estimate the downlink (DL) channel and/or received signal-to-noise ratio (SNR) based on the transmission. Then the UE can send reports to the BS indicative of the estimation and/or a desired beam selection determined based on the estimation. This process may be referred to as beam sweeping.

The number of orthogonal beams that must be transmitted in such an implementation is, typically, in the order of (e.g., equals or are at most equal to) the number of antennas (or antenna elements) at the BS. Thus, this approach may be useful when there is a low or moderate number of antenna elements. However, for situations with a large number of antenna elements (e.g., massive multiple-input multiple-output (MIMO)), the number of beams that needs to be transmitted becomes large which makes this approach cumbersome. For example, a substantial amount of time (and/or other communication resources, such as frequency, code, etc.) may need to be allocated for the training transmissions, and the training contributes with a large amount of overhead signaling, both of which may impair system capacity.

In such situations, the BS may instead transmit a lower number of beams than in the implementation referred to above; e.g., beams of a transmission codebook that contains less than all transmission beams and that preferably span as much as possible of the entire BS antenna space. This process may also be referred to as beam sweeping. Even in this approach, however, the amount of time and/or signaling overhead of the training transmissions may be substantial.

Therefore, there is a need for more efficient approaches for beam measurements (e.g., beam evaluation and/or beam selection). Preferably, such approaches require less resource (e.g., time and/or frequency) allocation and/or less signaling overhead than other approaches. Also preferable, such approaches achieve the same or only slightly inferior performance compared to optimum beam selection (e.g., in terms of signal-to-noise ratio, SNR, when the selected beams are used). If approaches achieve deteriorated results compared to optimum beam selection, it is preferable that the deterioration is minimal, or at least not substantial.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method for a control node of a wireless communication system. The wireless communication system comprises two or more transmission arrangements and a receiver arrangement, wherein each transmission arrangement is associated with a respective set of available beams for beam measurements.

The method comprises determining, for at least one transmission arrangement of the two or more transmission arrangements, a respective collection of linear combinations of available beams. At least one of the linear combinations comprises available beams from at least two sets of available beams associated with different transmission arrangements of the two or more transmission arrangements.

The method also comprises causing transmission, by the transmission arrangements, of at least one of the linear combinations of available beams for beam measurements by the receiver arrangement.

In some embodiments, causing transmission comprises transmitting one or more of the available beams of the at least one linear combination.

In some embodiments, causing transmission comprises providing an indication of the respective collection of linear combinations of available beams to the transmission arrangements.

In some embodiments, determining the respective collection of linear combinations of available beams for at least one transmission arrangement comprises determining a respective collection of linear combinations of available beams for each transmission arrangement.

In some embodiments, a cardinality of the respective collection of linear combinations of available beams for a transmission arrangement is lower than an accumulated cardinality, for all of the transmission arrangements, of the respective sets of available beams.

In some embodiments, determining the respective collection of linear combinations of available beams is based on one or more of: a sparsity of a channel between the two or more transmission arrangements and the receiver arrangement, and properties of a compression matrix representing the respective collections of linear combinations of available beams for all of the two or more transmission arrangements.

For example, determining the respective collection of linear combinations of available beams may comprise determining the cardinality of the respective collection of linear combinations of transmission beams based on one or more of: a sparsity of a channel between the two or more transmission arrangements and the receiver arrangement, and properties of a compression matrix representing the respective collections of linear combinations of available beams for all of the two or more transmission arrangements.

In some embodiments, the respective collection of linear combinations of available beams is defined by an exclusive part of a Grassmannian coding matrix.

In some embodiments, respective collections of linear combinations of available beams for the two or more transmission arrangements, each respective collection representable by a matrix Bₖ, are determined such that A^{H} A is a substantially block diagonal matrix, wherein A=B⊗I, B=[B₁ . . . Bₖ . . . B_{K}], and ⊗ represents Kronecker product.

In some embodiments, causing transmission, by the transmission arrangements, of at least one of the linear combinations of available beams comprises causing one or more of: transmission of the linear combinations of available beams in respective transmission time resources, at least some of the respective time resources being different, and transmission of the linear combinations of available beams in respective transmission frequency resources, at least some of the respective frequency resources being different.

In some embodiments, causing transmission of at least one of the linear combinations of available beams of one of the two or more transmission arrangements comprises causing the transmission in a transmission resource which is also used for transmission, by another one of the two or more transmission arrangements, of a linear combination of its respective collection.

In some embodiments, the method is applied, for at least one of the transmission arrangements, during a training phase for beam selection and/or for beam evaluation.

In some embodiments, the method further comprises receiving a beam measurement report from the receiver arrangement, and selecting a beam for communication based on the received beam measurement report.

In some embodiments, determining the respective collection of linear combinations of available beams for at least one transmission arrangement further comprises estimating a value of a cost function based on the determined respective collection of linear combinations of available beams, and wherein determining is iteratively repeated until a cost function condition is met.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is an apparatus for a control node of a wireless communication system. The wireless communication system comprises two or more transmission arrangements and a receiver arrangement, wherein each transmission arrangement is associated with a respective set of available beams for beam measurements. The apparatus comprising controlling circuitry.

The controlling circuitry is configured to cause determination, for at least one transmission arrangement of the two or more transmission arrangements, of a respective collection of linear combinations of available beams. At least one of the linear combinations comprises available beams from at least two sets of available beams associated with different transmission arrangements of the two or more transmission arrangements.

The controlling circuitry is also configured to cause transmission, by the transmission arrangements, of at least one of the linear combinations of available beams for beam measurements by the receiver arrangement.

The third aspect may be formulated as the apparatus comprising a determiner and a transmission causer. The determiner is configured to determine, for at least one transmission arrangement of the two or more transmission arrangements, a respective collection of linear combinations of available beams. At least one of the linear combinations comprises available beams from at least two sets of available beams associated with different transmission arrangements of the two or more transmission arrangements. The transmission causer is configured to cause transmission, by the transmission arrangements, of at least one of the linear combinations of available beams for beam measurements by the receiver arrangement.

A fourth aspect is a control node comprising the apparatus of the third aspect.

In some embodiments, the control node may further comprise one or more of the two or more transmission arrangements and/or a receiver arrangement.

A fifth aspect is a user equipment, UE, comprising the apparatus of the third aspect.

In some embodiments, the UE may further comprise one or more of the two or more transmission arrangements and/or a receiver arrangement.

A sixth aspect is a wireless communication system. The wireless communication system comprises a control node, two or more transmission arrangements, and a receiver arrangement. Each transmission arrangement is associated with a respective set of available beams for beam measurements. The control node is configured to cause determination, for at least one transmission arrangement of the two or more transmission arrangements, of a respective collection of linear combinations of available beams. At least one of the linear combinations comprises available beams from at least two sets of available beams associated with different transmission arrangements of the two or more transmission arrangements. The control node is also configured to cause transmission, by the transmission arrangements, of at least one of the linear combinations of available beams for beam measurements by the receiver arrangement.

In some embodiments, any of the above aspects may additionally have features identical with or corresponding to any of the various features as explained above for any of the other aspects.

An advantage of some embodiments is that alternative approaches for beam measurements (e.g., beam evaluation and/or beam selection) are provided.

The alternative approaches may, in some embodiments, be more efficient than other approaches for beam selection. Efficiency may, for example, be in terms of the amount of resource utilization (e.g., time and/or frequency) and/or signaling overhead needed for beam training.

The alternative approaches may, in some embodiments, require less resource (e.g., time and/or frequency) allocation and/or less signaling overhead than other approaches for beam selection.

The alternative approaches may, in some embodiments, achieve beam selection that is not severely deteriorated compared to other approaches for beam selection that may use more time, frequency, or signaling resources (e.g., in terms of resulting received SNR of the selected beam).

An advantage of some embodiments is that a significant reduction of training overhead for beam sweeping may be achieved at the cost of a marginal increase in error probability when compared to detecting the best combination of transmission-reception beams.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a flowchart illustrating example method steps according to some embodiments;

FIG. 2 is a signaling diagram illustrating example signaling according to some embodiments;

FIG. 3 is a schematic block diagram illustrating an example apparatus according to some embodiments;

FIG. 4 is a schematic block diagram illustrating an example apparatus according to some embodiments;

FIG. 5 is a simulation plot illustrating example results achievable by application of some embodiments;

FIG. 6 is a schematic drawing illustrating an example computer readable medium according to some embodiments;

FIG. 7 illustrates a telecommunication network connected via an intermediate network to a host computer in accordance with some embodiments;

FIG. 8 illustrates a host computer communicating via a base station with a user equipment over a partially wireless connection in accordance with some embodiments;

FIG. 9 is a flowchart illustrating example method steps implemented in a communication system including a host computer, a base station and a user equipment in accordance with some embodiments;

FIG. 10 is a flowchart illustrating example method steps implemented in a communication system including a host computer, a base station and a user equipment in accordance with some embodiments;

FIG. 11 is a flowchart illustrating example method steps implemented in a communication system including a host computer, a base station and a user equipment in accordance with some embodiments; and

FIG. 12 is a flowchart illustrating example method steps implemented in a communication system including a host computer, a base station and a user equipment in accordance with some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

In the following, embodiments will be described where alternative approaches for beam measurements (e.g., beam evaluation and/or beam selection) are provided.

Generally, when the term “beam” is used herein, it may refer to a transmission beam and/or to a reception beam.

Also generally, the embodiments described herein for a control node may be equally applicable to a user equipment, UE (e.g., relating to UE beamforming for the uplink).

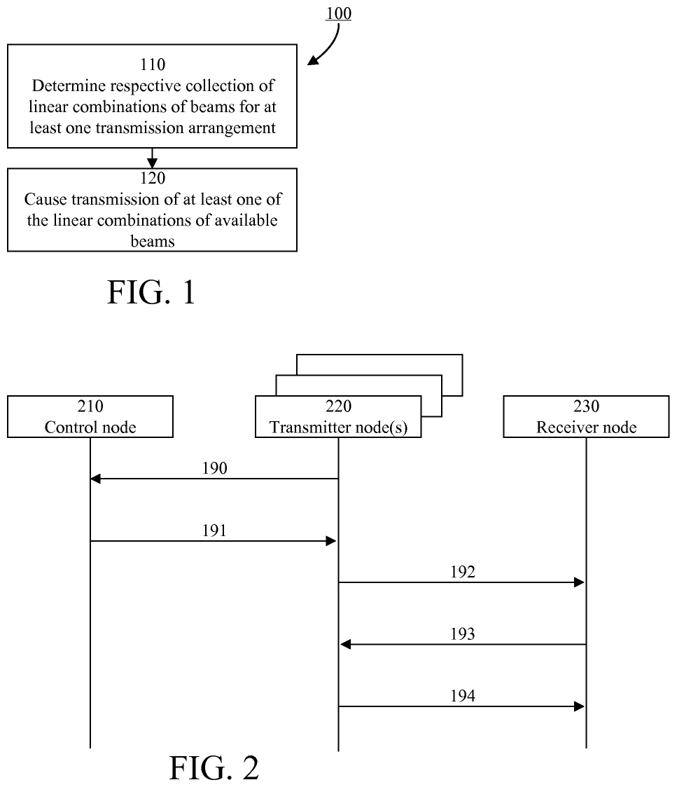

FIG. 1 illustrates an example method 100 according to some embodiments, and FIG. 2 illustrates example signaling according to some embodiments. The example signaling illustrated in FIG. 2 may be seen as a scenario where the method of FIG. 1 is applied.

The example method 100 is for a control node of a wireless communication system. The wireless communication system comprises two or more transmission arrangements and at least one receiver arrangement. The control node may be a network node, such as a transmitter node or a node, which is not a transmitter node (e.g., a server node). When the control node is a transmitter node, it may comprise one or more of the two or more transmission arrangements.

The example method 100 and/or the signaling of FIG. 2 may be applied during a training phase for beam selection (and/or for beam evaluation) for at least one (e.g., each) of the transmission arrangements.

The term “transmission arrangement” may, for example, refer to a transmitter node (e.g., a base station), or to an apparatus comprised therein such as an antenna panel of a transmitter node. When a transmission arrangement is interpreted as an antenna panel, one, two, or more transmission arrangements may be comprised in a single transmitter node.

In any case, each transmission arrangement is associated with a respective set of available beams for beam measurements (e.g., beam evaluation and/or beam selection). The respective set of available beams for beam measurements represent sounding beams for the corresponding transmission arrangement, and may typically be defined by a beam forming codebook of the transmission arrangement. Transmission arrangements comprised in a single transmitter node are typically associated with different beam forming codebooks.

Although not shown in FIG. 1, the method may comprise receiving (or otherwise acquiring) information regarding the respective sets of available beams of the transmission arrangements (e.g., the codebooks of the transmission arrangements).

In step 110 of the example method 100, a respective collection of linear combinations of available beams is determined for at least one transmission arrangement of the two or more transmission arrangements. For example, a respective collection of linear combinations of available beams may be determined for all (i.e., each) of the two or more transmission arrangements (centralized determination), or a respective collection of linear combinations of available beams may be determined for transmission arrangement(s) that are co-located with the control node (distributed determination).

Generally, if the available beams are termed initial available beams, the respective collection of linear combinations of available beams may be seen as a set of adjusted available beams, wherein each of the adjusted available beams is a linear combination of initial available beams.

At least one of the linear combinations comprises available beams from at least two sets of available beams associated with different transmission arrangements of the two or more transmission arrangements. This may entail the advantage that a transmission arrangement has a larger available sounding space than it would have if all linear combinations associated with it comprised only available beams from its own set of available beams.

Typically, at least one (preferably several, or all) available beam is comprised in two or more linear combinations; possibly for different transmission arrangements of the two or more transmission arrangements. This may entail the advantage that several (e.g., all) transmission arrangements have the same available sounding space. When this available sounding space has a lower dimensionality than an accumulation of dimensionalities of the sets of available beams for all of the transmission arrangements, the total number of beams to be sounded for all of the transmission arrangements is decreased.

Generally, when determining the respective collection of linear combinations of available beams is for a first transmission arrangement, and when a linear combination comprises beams from at least two sets of available beams associated with different transmission arrangements; the different transmission arrangements may comprise the first transmission arrangement and one or more second transmission arrangements.

Alternatively and also generally, when determining the respective collection of linear combinations of available beams is for a first transmission arrangement, and when a linear combination comprises beams from at least two sets of available beams associated with different transmission arrangements, the different transmission arrangements may comprise two or more second transmission arrangements only (i.e., not the first transmission arrangement).

Typically, the cardinality of the respective collection of linear combinations of available beams for a transmission arrangement is lower than an accumulated cardinality (for all of the transmission arrangements) of the respective sets of available beams. This may, for example, apply to any of the two or more transmission arrangements, or to all of the two or more transmission arrangements. The above cardinality circumstances may entail the advantage that the total number of beams to be sounded for all of the transmission arrangements is lower than if linear combinations associated with a transmission arrangement comprised only available beams from the set of available beams of that transmission arrangement.

Determining the respective collection of linear combinations of available beams may, for example, be based on a sparsity of a channel between the two or more transmission arrangements and the receiver arrangement and/or on properties of a compression matrix representing the respective collections of linear combinations of available beams for all of the two or more transmission arrangements.

An example of using properties of a compression matrix representing the respective collections of linear combinations of available beams for all of the two or more transmission arrangements, the respective collections of linear combinations of available beams for the two or more transmission arrangements may be determined such that A^{H} A is a substantially block diagonal matrix, wherein A=B⊗I, B=[B₁ . . . Bₖ . . . B_{K}], each respective collection of linear combinations is represented by a matrix Bₖ, and ⊗ represents Kronecker product

One way to achieve this is to let the respective collections of linear combinations of available beams be defined by a Grassmannian coding matrix, wherein an exclusive (i.e., non-overlapping) part of the Grassmannian coding matrix is used for each transmission arrangement. For example, a number of columns of the Grassmannian coding matrix may define the collection of linear combination for each transmission arrangements, wherein no column is used to define the collection of linear combination for more than one transmission arrangement.

In some embodiments, step 110 also comprises estimating a value of a cost function based on the determined collection of linear combinations of available beams, and iterating the determination of the collection of linear combinations until a cost function condition is met.

In step 120 of the example method 100, it is illustrated that the method comprises causing transmission, by the transmission arrangements, of at least one of the linear combinations of available beams for beam measurements by the receiver arrangement.

Typically, when a linear combination comprises beams from at least two sets of available beams associated with different transmission arrangements, transmission of the linear combination of available beams comprises coordinated transmission, from each of the different transmission arrangements, of the available beams in the linear combination (i.e., each transmission arrangement transmits the available beams in the linear combination that are comprised in its own set of available beams). Hence, the transmission of such a linear combination of available beams may be achieved by over-the-air combination of available beams transmitted from the different transmission arrangements.

Causing transmission may, for example, comprise transmitting one or more of the available beams of the at least one linear combination. This is particularly applicable when a transmission arrangement is co-located with the control node and has the one or more available beams in its set of available beams.

Alternatively or additionally, causing transmission may, for example, comprise providing an indication of the respective collection of linear combinations of available beams to the transmission arrangements. This is particularly applicable for a transmission arrangement that is not co-located with the control node.

Generally, transmission of the linear combinations of available beams may be in respective transmission time resources (at least some of the respective time resources being different) and/or in respective transmission frequency resources (at least some of the respective frequency resources being different). Thus, at least some of the linear combinations of available beams are transmitted using different transmission resources.

Other alternatives than time/frequency resources exist to differentiate the different linear combinations of available beams at transmission. For example, sounding reference signals (SRS:s) can be orthogonalized using so-called cyclic shifts (see Third Generation Partnership Project, 3GPP, technical specification, TS, 38.211, sec. 6.4.1.4.2) resulting in small time shifts in the time-domain, within the duration of the OFDM symbol, so that a receiver channel estimator can resolve the SRS:s. Another example relates to channel state information reference signals (CSI-RS), which can be orthogonalized in the coding domain using code division multiplexing (CDM) with orthogonal cover codes (OCC) in time and/or frequency domain (see 3GPP TS38.211, sec. 7.4.1.5.3).

That an available beam is comprised in two or more linear combinations may be utilized in step 120 to reduce the number of transmission resources needed for beam measurements. For example, transmission of a linear combination of available beams of one transmission arrangement may use a transmission resource which is also used for transmission of a linear combination of available beams of another transmission arrangement (e.g., transmission of an available beam by a transmission arrangement may contribute to two or more linear combinations—of the same or different transmission arrangements).

Although not shown in FIG. 1, the example method 100 may further comprise receiving a beam measurement report from the receiver arrangement, and selecting a beam for communication based on the received beam measurement report. These steps may be performed using any suitable (known or future) approaches for beam measurement reporting and beam selection. For example, the beam measurement report may indicate a desired beam and the beam selection comprise selecting the indicated desired beam. Alternatively, the beam measurement report may indicate measurement metrics for two or more of the linear combinations and the beam selection may comprise using the measurement metrics to determine a suitable beam.

FIG. 2 illustrates a centralized determination scenario, wherein the control node does not include any of the transmission arrangements. In FIG. 2, the wireless communication system is illustrated as comprising a control node 210, a number of transmitter nodes 220 (exemplifying the two or more transmission arrangements) and a receiver node 230 (illustrating the at least one receiver arrangement). The example signaling illustrated in FIG. 2 is signaling between the control node 210 and the transmitter nodes 220 and between the transmitter nodes 220 and the receiver node 230.

The signaling may commence by each of the transmitter nodes 220 transmitting information 190 regarding their respective sets of available beams (e.g., their codebooks), which information is received by the control node.

The control node 210 determines a respective collection of linear combinations of available beams for each of the transmitter nodes 220 (compare with step 110 of FIG. 1). At least one of the linear combinations comprises available beams from at least two sets of available beams associated with different transmitter nodes.

The control node 210 provides (transmits) an indication 191 of the respective collection of linear combinations of available beams, which indication is received by the transmitter nodes 220. Generally, the indication 191 may comprise specific indications (one for each transmission arrangement) relating to respective ones of the linear combinations, or the indication 191 may comprise a general indication (the same for all transmission arrangements) relating to all of the linear combinations.

The transmitter nodes 220 then transmit one or more of the available beams of the linear combinations 192. Thereby, the provision of the indication 191 by the control node 210 causes transmission, by the transmission arrangements, of one or more of the available beams of the linear combinations (compare with step 120 of FIG. 1).

Generally, for transmission of a linear combination of available beams, each of the available beams of the linear combination may be transmitted using the same transmission resource (e.g., a time/frequency resource).

Also generally, the transmission may be from a single transmission arrangement (when all available beams of the linear combination belong to the set of available beams of that transmission arrangement) or from two or more transmission arrangements (when the available beams of the linear combination belong to different sets of available beams; sets of the transmission arrangements executing the transmission).

Typically, when a linear combination comprises beams from at least two sets of available beams associated with different transmission arrangements, transmission of the linear combination of available beams comprises coordinated transmission, from each of the different transmission arrangements, of the available beams in the linear combination.

Thus, the transmission 192 may, for each of the linear combinations, be from one of the transmitter nodes or from several ones of the transmitter nodes. The transmissions 192 of linear combinations of available beams are utilized for beam measurements by the receiver node 230.

The receiver node 230 may then send a beam measurement report 193, which report is received by the transmitter nodes. Generally, the beam measurement report 193 may comprise specific reports (one for each transmission arrangement) relating to measurements of respective ones of the linear combinations, or the beam measurement report 193 may comprise a general report (the same for all transmission arrangements) relating to measurements of all of the linear combinations.

The transmitter nodes 220 select a respective beam for communication based on the received beam measurement report and use the selected beam for communication transmissions 194 towards the receiver node 230.

Due to that the available beams of all of the transmission arrangements may be utilized by the beam measurements for any of the transmission arrangements, the beam sounding transmissions 192 are more efficient in terms of transmission resources than if beam measurements for each of the transmission arrangements only utilized its own available beams.

FIG. 2 may be seen as illustrating an example of a wireless communication system comprising a control node, two or more transmission arrangements, and a receiver arrangement, wherein each transmission arrangement is associated with a respective set of available beams for beam measurements, wherein the control node is configured to cause determination, for at least one transmission arrangement of the two or more transmission arrangements, of a respective collection of linear combinations of available beams (at least one of the linear combinations comprising available beams from at least two sets of available beams associated with different transmission arrangements of the two or more transmission arrangements), and wherein the control node is also configured to cause transmission, by the transmission arrangements, of at least one of the linear combinations of available beams for beam measurements by the receiver arrangement.

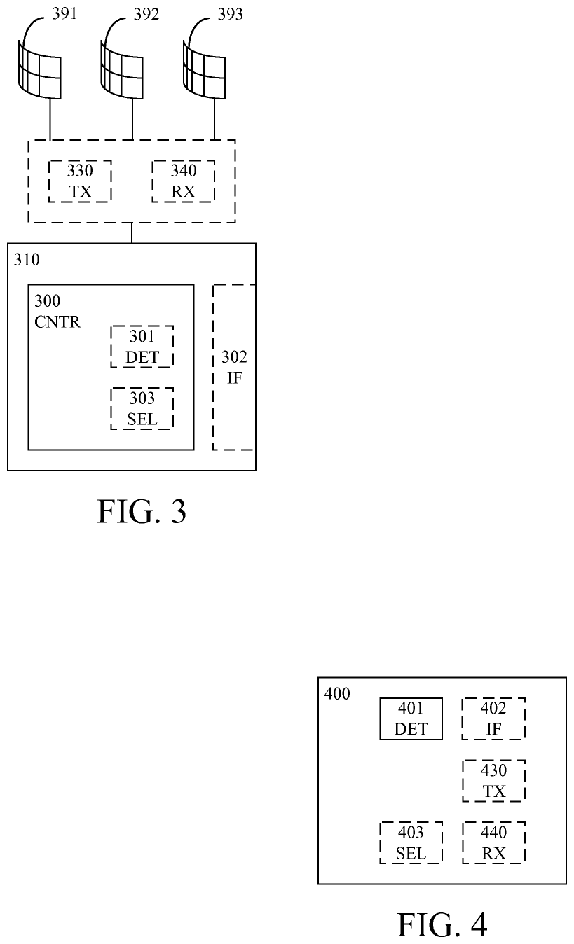

FIG. 3 schematically illustrates an example apparatus 310 according to some embodiments. The example apparatus 310 is for a control node (e.g., the control node 210 of FIG. 2) of a wireless communication system wherein the wireless communication system comprises two or more transmission arrangements and a receiver arrangement, and wherein each transmission arrangement is associated with a respective set of available beams for beam measurements. The example apparatus 310 may, for example, be configured to cause performance of (e.g., perform) any of the method steps described in connection with any of FIGS. 1 and 2, or otherwise mentioned herein.

The control node may comprise, or be co-located with, one or more of the transmission arrangements as illustrated in FIG. 3 by the antenna panels 391, 392, 392. Alternatively or additionally, the control node and one or more of the transmission arrangements may reside in different locations.

The example apparatus 310 comprises a controller (CNTR; e.g., controlling circuitry or a control module) 300.

The controller 300 is configured to cause determination, for at least one transmission arrangement, of a respective collection of linear combinations of available beams, wherein at least one of the linear combinations comprises available beams from at least two sets of available beams associated with different transmission arrangements of the two or more transmission arrangements (compare with step 110 of FIG. 1).

To this end, the controller 300 may comprise, or be otherwise associated with (e.g., be connected, or connectable, to) a determiner (DET; e.g., determination circuitry or a determination module) 301. The determiner 301 may be configured to determine the respective collection(s) of linear combinations of available beams (compare with step 110 of FIG. 1).

The controller 300 is configured to cause transmission, by the transmission arrangements, of at least one of the linear combinations of available beams for beam measurements by the receiver arrangement (compare with step 120 of FIG. 1 and signaling 191, 192 of FIG. 2).

To this end, the controller 300 may comprise, or be otherwise associated with (e.g., be connected, or connectable, to) an interface (IF; e.g., interface circuitry or an interface module) 302. The interface 302 may be configured to provide an indication of the respective collection of linear combinations of available beams to the transmission arrangements, thereby causing transmission of the linear combination(s).

Alternatively or additionally, the controller 300 may comprise, or be otherwise associated with (e.g., be connected, or connectable, to) a transmitter (TX; e.g., transmission circuitry or a transmission module) 330 associated with a transmission arrangement 391, 392, 393 comprised in the control node. The transmitter 330 may be configured to transmit one or more of the available beams of a linear combination via the transmission arrangement 391, 392, 393, thereby causing transmission of the linear combination(s).

Any of the interface 302 and the transmitter 330 may be seen as a transmission causer, configured to cause transmission (by the transmission arrangements) of at least one of the linear combinations of available beams for beam measurements by the receiver arrangement.

The controller 300 may also be configured to cause reception of a beam measurement report from the receiver arrangement (compare with signaling 193 of FIG. 2). To this end, the controller 300 may comprise, or be otherwise associated with (e.g., be connected, or connectable, to) a receiver (REC; e.g., reception circuitry or a reception module) 340. The receiver may be configured to receive the beam measurement report.

The controller 300 may also be configured to cause selection of a beam for communication based on the received beam measurement report. To this end, the controller 300 may comprise, or be otherwise associated with (e.g., be connected, or connectable, to) a selector (SEL; e.g., selection circuitry or a selection module) 303. The selector may be configured to select a beam for communication based on the received beam measurement report.

FIG. 4 schematically illustrates an example apparatus 400 according to some embodiments. The example apparatus 400 is for a control node (e.g., the control node 210 of FIG. 2) of a wireless communication system wherein the wireless communication system comprises two or more transmission arrangements and a receiver arrangement, and wherein each transmission arrangement is associated with a respective set of available beams for beam measurements. The example apparatus 400 may, for example, be configured to cause performance of (e.g., perform) any of the method steps described in connection with any of FIGS. 1 and 2, or otherwise mentioned herein. The example apparatus 400 may, for example, be a controller (e.g., a control module).

The example apparatus 400 is configured to cause determination, for at least one transmission arrangement, of a respective collection of linear combinations of available beams, wherein at least one of the linear combinations comprises available beams from at least two sets of available beams associated with different transmission arrangements of the two or more transmission arrangements (compare with step 110 of FIG. 1).

To this end, the example apparatus 400 may comprise a determiner (DET; e.g., a determination module) 401. The determiner 401 may be configured to determine the respective collection(s) of linear combinations of available beams (compare with step 110 of FIG. 1).

The example apparatus 400 is also configured to cause transmission, by the transmission arrangements, of at least one of the linear combinations of available beams for beam measurements by the receiver arrangement (compare with step 120 of FIG. 1 and signaling 191, 192 of FIG. 2).

To this end, the example apparatus 400 may comprise an interface (IF; e.g., an interface module) 402. The interface 402 may be configured to provide an indication of the respective collection of linear combinations of available beams to the transmission arrangements, thereby causing transmission of the linear combination(s).

Alternatively or additionally, the example apparatus 400 may comprise a transmitter (TX; e.g., a transmission module) 430. The transmitter 430 may be configured to transmit one or more of the available beams of a linear combination, thereby causing transmission of the linear combination(s).

Any of the interface 402 and the transmitter 430 may be seen as a transmission causer, configured to cause transmission (by the transmission arrangements) of at least one of the linear combinations of available beams for beam measurements by the receiver arrangement.

The example apparatus 400 may also be configured to cause reception of a beam measurement report from the receiver arrangement (compare with signaling 193 of FIG. 2). To this end, the example apparatus 400 may comprise a receiver (REC; e.g., a reception module) 440. The receiver may be configured to receive the beam measurement report.

The example apparatus 400 may also be configured to cause selection of a beam for communication based on the received beam measurement report. To this end, example apparatus 400 may comprise a selector (SEL; e.g., a selection module) 403. The selector may be configured to select a beam for communication based on the received beam measurement report.

In some embodiments, the processes described herein may be seem as an implementation of joint beam encoding; over transmission arrangements.

In radio access technology standards for operation in high frequencies that heavily rely upon beamforming, such as 5G NR and IEEE 802.11ay, an important procedure for a transmitting node (termed as “node T” or node of “type T” in the following) is to find the best—or at least an acceptably good—beam towards a receiving node (termed “node R” or node of “type R” in the following). As understood from the above, a transmitting node may comprise one or more transmission arrangements. The finding of a beam (e.g., beam measurements, beam evaluation, beam selection) may be performed in the transmitting node, in another transmitting node, in the receiving node, in a control node, or in a combination of one or more of these nodes.

One way of finding of a beam is to have the node T transmit reference signals beam formed with orthogonal beams spanning the entire channel, which enables the node R to estimate the quality (e.g. by measuring the reference signal received power, RSRP) of each beam. This procedure may be referred to as beam sweeping (or sounding). Typically, the number of orthogonal beams that must be transmitted (to enable estimation of the best transmit beam) equals, or is in the order of, the number of node T transmit antennas. Node R may then report the best beam (or a set of best beams) and/or quality estimates related to the best beam(s), so that node T can determine (select) the optimal beam (e.g. by linear combination of the best beams). Such mechanisms work well if the node T has few antennas. However, when operating in millimeter-wave systems for example, the node T is typically equipped with many antennas and the beam sweeping introduces substantial overhead, especially when beam sweeping of the large number of beams needs to be done in different time instances due to hardware constraints (e.g. analog beamforming implementation).

An alternative method to sounding the complete channel is that the node T transmits beams (compare with the set of available beams referred to above) from a codebook that contains less beams than the number of antennas, and that preferably span as much as possible of the whole antenna space. This procedure may also be referred to as beam sweeping. The node R may then estimate the quality for each codebook beam of the node T and report the index/indices of the best-quality beam(s) to the node T.

In some scenarios, the beam sweeping and beam selection may be performed in a hierarchical manner where an initial, coarse, beam sweep provides an initial estimate, or a relevant spatial region, to use for more refined beam sweeping (e.g. using synchronization signal block, SSB, reception info in NR), and the beam set used for sounding may be correspondingly reduced. Nevertheless, the number of beams to be sounded may be undesirably high.

Typically, beam sweeping is currently performed according to the traditional beam sweeping approaches, where the node T transmits reference signals for measurements on one of its available beams at a time and the node R feeds back the index of the best transmit beam. One example is the beam sweeping based on sounding reference signal (SRS) in NR uplink (UL), where a user equipment (UE) acts as node T and a generalized NodeB (gNB) acts as node R.

Also typically, the beams for sweeping in the node T are chosen as grid of beams with as high gain as possible by the array aperture. The reason for this choice of beams is that most multiple-input, multiple-output (MIMO) channels can be decomposed into a sum of plane waves from certain angles. Thus, by choosing the structure of the beams to be the same as the structure of the paths that constitute the MIMO channel, it is expected that some transmit beams will be well aligned with some (hopefully the strongest) paths of the MIMO channel.

In some scenarios, there emerges a beam evaluation task where a large number of beams from multiple node T:s need to be sounded during a limited time duration. The NR UL sounding context mentioned above is one example. If N denotes the number of beams in the beam sweeping codebook at each node T and K denotes the number of node T:s, the total number of beams to be swept (and thus the resource overhead used for beam sweeping) will be equal to KN. Clearly, if K and/or N is large, the resulting product is also large and requires a large amount of transmission resources (e.g., in time and/or frequency).

In the beam sweeping procedures described above, the number of sounding beams can be very large, especially when there are several node T that simultaneously need to optimize their beam towards node R. This results in high resource usage for beam measurements (beam evaluation, beam selection, beam training).

Thus, a problem with beam sweeping is that substantial overhead (e.g., in terms of used transmission resources) is needed. Furthermore, the beam sweep duration may have time constraints (e.g., due to varying channel properties for moving transmission and/or reception nodes), which requires the beam sweeping to be performed within a certain amount of time.

If the number of beams for sweeping is reduced, the resulting beam selection may typically be inferior (i.e., the best beam is not selected). Therefore, to keep the beam selection performance at an acceptable level, it may be very cumbersome to reduce the signaling overhead for beam sweeping.

Non-published International patent applications PCT/EP2018/064529 and PCT/EP2018/083166 disclose approaches to reduce the number of beams to be sounded wherein each node T is considered in isolation. In those approaches, a collection of linear combinations of available beams was determined for node T, wherein the cardinality of the collection was lower than the cardinality of the set of available beams of node T (i.e., the number of beams to be sounded was reduced by transmitting linear combinations of the codebook beams).

Herein, approaches to reduce the number of beams to be sounded are presented wherein two or more transmission arrangements (e.g., node T:s) are considered jointly. In these approaches, a collection of linear combinations of available beams is determined for a transmission arrangement, wherein at least one linear combination comprises beams from at least two different transmission arrangements. The cardinality of the collection for one transmission arrangement may be higher than, lower than, or equal to the cardinality of the set of available beams for the transmission arrangement. However, a sum of the cardinalities of the collections for all transmission arrangements is lower than a sum of the cardinalities of the sets of available beams for all transmission arrangements (i.e., the total number of beams to be sounded for all the transmission arrangements is reduced by transmitting linear combinations of codebook beams that may be combined from codebooks of different transmission arrangements).

Some embodiments result in a significant reduction of training overhead for beam sweeping at a marginal increase in error probability for detecting the best beam(s) for each transmission arrangement. The overhead reduction may be considered in terms of reduction in the total time/frequency transmit resource usage (reducing beam sounding impact on network capacity) and/or in terms of reduced duration of the total beam sounding procedure (mitigating challenges associated with stale channel state information, CSI, and/or lowering energy consumption associated with beam sounding and beam measurements).

Generally, the linear combinations may be determined in advance (e.g., off-line) and be pre-assigned to the transmission arrangements. Alternatively or additionally, the linear combinations may be determined in association with the beam sounding transmissions.

In the following, approaches to reduce the number of beams to be sounded for two or more transmission arrangements will be exemplified with reference to a matrix Fₖ which denotes the beam sweeping codebook for the k^{th} transmission arrangement. Thus, the columns of this matrix make up the set of available beams (the columns of Fₖ may, for example, correspond to discrete Fourier transform, DFT, beams). Hence, each transmission arrangement is associated with a respective set of available beams (represented by matrix Fₖ) for beam measurements.

Instead of each transmission arrangement transmitting each column of its own codebook (i.e., each beam in its set of available beams) using different transmission resources, new sets of beams (respective collections of linear combinations of available beams) are created for each transmission arrangement. The new set of beams for the k^{th} transmission arrangement may be denoted by a matrix Gₖ, and the construction of it may be expressed by the following linear transformation Gₖ=FₖBₖ^{T}, where (.)^{T} denotes matrix transposition. The matrix Bₖ^{T} can be seen as a spreading matrix. The new codebooks {Gₖ} (the respective collections of linear combinations of available beams) replace the original codebooks {Fₖ} for beam sweeping during the training phase.

For simplicity, it is assumed in the following that all transmission arrangements have the same number of antennas N, that all Fₖ are square matrices of dimension N, and that B^{T} (which is a joint encoding matrix, typically defined as a concatenation of all matrices Bₖ^{T} has L columns.

The total number of resources needed for beam sweeping of all transmission arrangements is L, and the transmission arrangements can spread their beams across the same transmission resource space (e.g., time/frequency resource grid).

When L<Σₖ Nₖ=KN, the total number of transmission resources needed is reduced. Preferably the matrices Bₖ^{T} are constructed such that L<<KN, while the probability of error for best beam selection is not significantly decreased. In some embodiments, the matrices Bₖ^{T} may be constructed by selecting them as sub-matrices of a Grassmannian matrix, where—typically—the sub-matrices assigned to different transmission arrangements are distinct and non-overlapping.

Typically, the goal of beam sweeping is that each transmission arrangement knows which beam (or which combination of beams) from its own codebook it should use when transmitting data to the receiver (compare with 194 of FIG. 2). This may be achieved by determining (typically at the receiver arrangement) which of the N values ∥HₖFₖ (:, n)∥, 1≤n≤N, is largest, where Hₖ denotes the channel matrix from the k^{th} transmission arrangement to the receiver arrangement, the operator ∥.∥ denotes the Frobenious norm, and ∥HₖFₖ (:, n)∥ is the effective channel gain (which is proportional to the SNR) when the k^{th} transmission arrangement uses beam n.

Approaches according to some embodiments suggest that, instead of transmitting the “original” beam codebooks Fₖ, transmission arrangements perform a linear encoding of the “original” beams. The new codebook of k^{th} transmission arrangement is given by Gₖ=FₖBₖ^{T}, where the matrix Bₖ^{T} is a linear encoding matrix. The linear encoding matrix transforms the original beams Fₖ into Gₖ. Thus, Gₖ contain the new beam codebook, meaning that the transmission arrangement k will transmit the columns from Gₖ during beam sweeping. Since the newly formed beams are a linear combination of the original beams, they contain information about the original beams as well.

The signals received by the receiver arrangement during beam sweeping may be denoted Y=[H₁ . . . H_{K}]FB^{T}+N, where the entries of N represent additive white Gaussian noise (AWGN), F represents all original beam matrices, and B^{T} represents the joint encoding matrix;

$$F = [ \begin{matrix}{F}_{1} & 0 & 0 \\ 0 & ⋱ & 0 \\ 0 & 0 & {F}_{K}\end{matrix} ] , B = [ \begin{matrix}{B}_{1} & … & {B}_{K}\end{matrix} ] = [ \begin{matrix}{b}_{1 , 1} & … & {b}_{1 , KN} \\ ⋮ & ⋱ & ⋮ \\ {b}_{L , 1} & … & {b}_{L , KN}\end{matrix} ] .$$

The columns of B^{T}, and of G=FB^{T}, represent different resources (e.g. OFDM symbols) used for beam sweeping.

It should be noted that the new joint codebook G=FB^{T} is, typically only used during the beam sweeping training phase, in order to learn the preferred beam(s) for each transmission arrangement. Thus, G is typically not constructed to replace the original beam codebook F for data transmission.

One goal of the encoding may be that B^{T} (and G) has less columns than F (e.g. that L<NK) so that less resources are needed for beam sweeping. Hence, a cardinality L of the respective collection of linear combinations of available beams for a transmission arrangement (the collection represented by a set of respective columns of G for each transmission arrangement) is lower than an accumulated cardinality NK, for all of the transmission arrangements, of the respective sets of available beams (the accumulation of all sets represented by F). Another goal is that this resource reduction is achieved at no (or only a small) decrease in performance of detecting the strongest beam for each transmission arrangement.

If the joint encoding matrix B^{T} has a block diagonal structure each transmission arrangement sweeps its own beams in resources orthogonal to those used by other transmission arrangements, and the encoding matrices Bₖ^{T} for each transmission arrangement can be set independently from the other encoding matrices.

Instead, embodiments herein suggest that B is not constrained to be a block diagonal matrix, and that any of its entries can take any value—in principle. This entails joint encoding between transmission arrangements, whereby all transmission arrangements may use all available resources for beam sweeping—in an overlapping manner. To achieve this, the encoding matrices B₁^{T} . . . B_{K}^{T} (should be determined jointly (e.g., so that the interference between transmission arrangements is structured and can be equalized with post-processing).

Hence, a respective collection of linear combinations of available beams is determined for at least one transmission arrangement of the two or more transmission arrangements (the collection represented by a set of respective columns of G for each transmission arrangement), and at least one of the linear combinations comprises available beams from at least two sets of available beams associated with different transmission arrangements of the two or more transmission arrangements (e.g., at least one column of G has at least one non-zero element outside the block diagonal structure representing independent encoding among transmission arrangements).

In contrast to traditional beam sweeping where a transmission arrangement performs N transmissions, one per available beam, each transmission arrangement transmits in the symbols that correspond to one of its columns in G having a non-zero element, where the element value is used as a precoding weight.

In the following, it will be exemplified how G may be determined, and thereby how the respective collections of linear combinations of available beams may be determined for the transmission arrangements. The exemplification will be in terms of desirable properties of G. One example matrix that has such properties is a Grassmannian coding matrix, which may thus be used as the matrix G, wherein the respective collection of linear combinations of available beams for a certain transmission arrangement may be defined by an exclusive part of the Grassmannian coding matrix (e.g., a certain set of columns of the matrix, wherein the certain set is non-overlapping with the sets of columns of other transmission arrangements).

Stacking all the columns of Y=[H₁ . . . H_{K}]FB^{T}+N=HFB^{T}+N into a column vector, denoting that column vector as y=vec(Y) and the noise vector as n=vec(N), a system model of the beam sweeping may be expressed as y=(B⊗I)c+n. Here, ⊗ denotes the matrix Kroenecker product, I is the identity matrix of size M (where M is the number of antennas of the receiver arrangement), c=vec(HF), and H=[H₁ . . . H_{K}] denotes the channel between transmitters and receivers, for example, a MIMO channel (the MIMO channel on a certain subcarrier in an OFDM system). When the receiver arrangement applies a reception codebook, I may be replaced by a corresponding matrix of size M.

According to some embodiments, it is possible to compress the original codebooks {Fₖ} at the cost of only limited increase in beam selection error when A=B⊗I is selected to have unitary-like properties, and/or when the vector c is sparse. Thus, determining the respective collection of linear combinations of available beams may be based on a sparsity of a channel between the two or more transmission arrangements and the receiver arrangement (which may be represented by sparsity of the vector c), and/or based on properties (e.g., unitary-like properties) of a compression matrix representing the respective collections of linear combinations of available beams for all of the two or more transmission arrangements (which may be represented by properties of A=B⊗I).

A sparse vector may, for example be defined as a vector where more than a threshold, e.g., a certain percentage (e.g., 80%, 90%, 95% or 99%), but less than all, of the elements equal zero.

Examples of unitary-like properties include a diagonal dominant structure and/or a low spread of non-zero eigenvalues.

A matrix with low spread of non-zero eigenvalues may, for example, be defined as a matrix where the ratio between the magnitude of the non-zero eigenvalue having the largest magnitude and the magnitude of the non-zero eigenvalue having the smallest magnitude is less than a certain percentage (e.g. 20%, 10%, 5%, 1%, 0,1%, 0,01%) of the number of non-zero eigenvalues.

A diagonal dominant structure of a matrix may, for example be defined as a matrix where all elements, which are offset to the diagonal with more than a threshold, e.g., a certain percentage (e.g., 1%, 2%, 3%, 5%, 10%, or 20%) of the number of rows (or columns) of the matrix, equal zero (or has a magnitude that is less than a threshold, e.g., a certain percentage (e.g., 1%, 2%, 3%, 5%, 10%, or 20%) of the largest magnitude of the matrix elements).

Alternatively, a diagonally dominant matrix may be defined as a matrix where the ratio between the sum of the magnitudes of the diagonal elements and the sum of the magnitudes of the non-diagonal elements is smaller than a threshold value (e.g. 1, 0.5, 0.1, 0.01); regardless of whether or not there are zero-valued off-diagonal elements.

One way of achieving that A has unitary-like properties is to select the joint coding matrix B such that A^{H} A is a substantially block diagonal matrix. For example, it may be achieved that A has unitary-like properties by letting the joint coding matrix B be a Grassmannian frame/matrix. Such a choice results in that the Gram of A (i.e., A^{H} A) has properties that—for detection purposes—resemble the properties of an identity matrix. For example, it has a diagonal dominant structure, and the spread between its non-zero eigenvalues is low. This entails that a simple detector (e.g., the one exemplified below) performs almost as good as maximum likelihood decoding.

As mentioned before, each transmission arrangement uses a sub-matrix (a specified set of columns) of B to encode its beam transmissions. The sub-matrices used by different transmission arrangements typically do not overlap. It may be preferable that the receiver arrangement broadcasts an index indicating which (e.g., out of several tabulated) joint encoding matrix B should be used, and—for each transmission arrangement—an indication of the specified set of columns that should be used.

In some embodiments with multi-antenna receiver arrangements, the performance of the joint Grassmannian matrix design may be improved by additionally utilizing spatial separation between groups of transmission arrangements.

Signal leakage between non-orthogonal spreading sequences is higher if the Grassmannian matrix is to accommodate more sequences for the same sequence length (number of transmission arrangement antennas). It may therefore be desirable to reduce the number of sequences.

This may be done by providing unique sequences to transmission arrangements in a first group that cannot be separated spatially (e.g. situated in a close contiguous area of the cell), while reusing the same set of sequences for a second group of transmission arrangements that can be spatially separated from the first group of transmission arrangements.

This approach may be particularly suitable for stationary or semi-stationary transmission arrangements whose locations or spatial correlations can be established prior to codebook allocation. Codebook allocations of slowly moving transmission arrangements may updated over time.

Example approaches for the receiver arrangement will now be described, where the rule for detecting the supposedly best beam is very simple; a matched filter (matched to the encoding matrix B, or more generally to A), followed by an energy detector.

The matched filer typically acts as an equalizer to the beam compression/encoding, providing the output z=A^{H} y, where z is a MKN×1 column vector.

The supposedly strongest beams (e.g., one per transmission arrangement) may then be detected as \hat{l}ₖ=arg maxₙ∥w_{(k-1)N+n}∥, where \hat{l}ₖ represents the index of the supposedly strongest beam for the k^{th} transmission arrangement, w_{(k-1)N+n} is a column of the M×KN matrix \tilde{W}=vect⁻¹(z)=[W₁ . . . W_{K}]=[w₁ . . . w_{KN}], where Wₖ=[W_{(k-1)N+1} . . . W_{(k-1)N+N}]. This detection rule may be adjusted to detect a selection of several best beams per transmission arrangements as suitable.

Alternative embodiments for the receiver arrangement include using least square (LS) or minimum mean square error (MMSE) equalization instead of the matched filter equalization.

The non-zero elements in c, other than the ones with largest magnitude, act as interference for the detector. Thus, sparsity of c ensures that the detector experiences low interference. This sparsity may exist for some channels, e.g., in mmWave channels. The sparsity of c also ensures that a fat structure of matrix A does not result in an ill-posed detection problem, since only a few columns of A are activated at a time.

In some embodiments, determining the respective collections of linear combinations of available beams for the transmission arrangements (e.g., determining the joint coding matrix B) may further comprise estimating a value of a cost function based on the determined respective collections, and iterating the determination of the respective collections until a stopping criterion (e.g., a cost function condition) is met. Generally, any suitable stopping criterions may be used for the iteration; for example one or more of a maximum number of iterations, a minimum change in the cost function between iterations, the cost function falling of a specified side of a cost function threshold, etc.

The cost function may, for example relate to a magnitude (or envelope) variation (e.g., expressed as a peak-to-average ratio, PAR, and/or in terms of a constant-modulus property), wherein the cost function condition is that the variation should be below some variation threshold value.

For example, the cost function J(.) may be related to a Generalized Welsh Bound formulation; e.g., the cost function condition may aim at finding the joint coding matrix B that minimizes

$$J ( B ) = ( {\sum }_{i , j} {\vert {b}_{i}^{H} {b}_{j} \vert}^{2} ) / {( {\sum }_{m} {b}_{m}^{H} {b}_{m} )}^{2} ,$$

where bₘ denotes the m^{th} column of B.

Alternatively or additionally, the cost function condition may relate to that the magnitude of each entry of the transmitted signals matrix G should be equal to one, or should deviate from one by less than a threshold value.

Various approaches are possible for where and when the determination of respective collection of linear combinations of available beams (compare with step 110) is performed, as well as for what type of signaling is used to configure the transmission arrangements.

For example, the network (comprising the control node) may have a set of pre-determined matrices B (or G) for handling a maximum of K transmission arrangements sweeping N beams each. The control node may then configure up to K transmission arrangements with their respective codebook information Bₖ^{T} or Gₖ^{T}. The control node may switch codebook sets as the number of transmission arrangements changes and reconfigure the transmission arrangements accordingly.

The codebooks (or their design criteria) may be tabulated in standard specification documents, for example. Alternatively or additionally, the codebooks may be provided via system information (SI) or via be radio resource control (RRC) signaling.

Some example scenarios where embodiments may be applicable include (but are not limited to):
UL sounding from a multi-panel UE, or from multiple UEs with large arrays
DL CSI-RS transmission for link adaptation (LA) and multi-antenna rank/precoding selection from multiple antenna panels in a distributed/multi-site MIMO deployment
   individual transmission/reception points (TRPs) or gNB antenna panels are the multiple transmission arrangements, UE is receiver arrangement
DL CSI-RS transmission for beam management (BM) or mobility measurements from multiple TRPs
   individual TRPs or neighbour gNBs are the multiple transmission arrangements, UE is receiver arrangement
Joint beam compression during uplink beam sweeping (e.g. using SRS) from different antenna panels of a UE (e.g., in the multi-beam use case in the context of NR Rel-16 enhanced MIMO, eMIMO, work item (WI))
   individual panels of the UE are the multiple transmission arrangements; gNB is receiver arrangement
Joint beam compression during uplink beam sweeping (e.g. using SRS) from different UEs (as e.g. in UL multi-user MIMO, MU-MIMO, for fixed wireless access (FWA) or evolved mobile broadband (eMBB) use cases);
   individual UEs are the multiple transmission arrangements; gNB is receiver arrangement
Joint beam compression during uplink/downlink beam sweeping from different relays (e.g., in integrated access and backhaul (IAB) use cases);
   individual relays are the multiple transmission arrangements; gNB or another relay is receiver arrangement
Joint beam compression during downlink/uplink (e.g., over Uu interface) or sidelink (e.g., over PC5 interface) beam sweeping from different vehicle-mounted UEs (as e.g. cellular vehicle-to-other (C-V2X) use cases);
   individual vehicle-mounted UE are the multiple transmission arrangements; gNB is receiver arrangement
   individual vehicle-mounted UE are the multiple transmission arrangements; vehicle-mounted UE is receiver arrangement.

The joint encoding codebooks and procedures may be designed based on constraints for total resource usage (e.g., resource elements, RE, or physical resource block (PRB) occupied by sweeping signals) for resource savings and/or limited network capacity impact. Alternatively or additionally, the joint encoding codebooks and procedures may be designed based on maximal sweep duration constraints (e.g., number of slots or orthogonal frequency division multiplexing, OFDM, symbols required to complete the sweep) for enabling provision of up-to-date CSI and/or measurement info in rapidly varying environments, and/or for reducing the transceiver on-time of the transmission arrangement to minimize energy consumption.

In some embodiments (e.g., for simultaneous transmission from multiple UEs to the network), there may be an overhead associated with coordination and distribution of the encoding codebooks. Such overhead may be minimized, e.g., by applying approaches presented herein primarily (or only) to groups of UEs with stable transmission patterns and low mobility. Thereby, group structures and codebook contents only need to be updated infrequently.

In some embodiments (e.g., for multiple panels at UE or BS), such overhead is not required since the number of panels is constant and suitable codebooks for different antenna/panel configurations may be predefined (e.g., in specifications).

It should be noted in particular that some embodiments may be particularly suitable in relation to 5G NR (see, e.g., 3GPP TS 38.214, TS 38.212, TS 38.211), where application for certain sections is exemplified below.

References are given to configuration signaling, transmission resources, and codebooks of 5G NR that may be used in the context of some embodiments. Codebooks of 5G NR may be used as the sets of available beams in the wording used herein (even if they are not actually used for beam sounding according to the standardization documents). Signaling specified for 5G NR may be used to provide the indication of the respective collection of linear combinations to the transmission arrangements in the wording used herein. Transmission resources specified for 5G NR may be used to transmit the available beams of a linear combination in the wording used herein.
TS 38.214
   Sec. 5.2 UE procedure for reporting channel state information (CSI)
      Especially Sec. 5.2.2.2 Precoding matrix indicator (PMI)
         Note that these (single-panel or multi-panel) codebooks are not actually used for sounding gNB antenna panel(s), but for quantizing the downlink channel before feedback (UE report). The reported PMI is only a recommendation; the gNB actually chooses the precoder freely (i.e. transparent to UE).
         Note that the specified codebooks in NR (and LTE) are constant modulus.
   Sec. 6.1. UE procedure for transmitting the physical uplink shared channel
      6.1.1.1 Codebook based UL transmission
         Note that the (uplink) codebook are not actually used for sounding UE antennas, but for quantizing the uplink channel. The UE is dictated by the gNB to use the reported transmit precoder matrix indicator (TPMI).
      6.1.1.2 Non-codebook based UL transmission
         Note that in this mode, the beams used during sounding (of each UE) are transparent (i.e., not part of the specification). Embodiments may still be relevant (and perhaps even more so), as they provide an efficient way to determine which beams to use when sounding simultaneously more than one UEs (or antenna panels in general).
      Sec. 6.2.1 UE sounding procedure
         Describes configuration of SRS resources used for UL sounding.
TS 38.212
   7.3.1.1 DCI formats for scheduling of PUSCH (physical uplink shared channel)
      Describes the signaling (SRS Resource Indicator—SRI, TPMI, Transmit Rank Indicator—TRI, . . . ) format used by the network controller (gNB) towards the UE
TS 38.211
   6.3.1.5 Precoding
      Specifies the uplink codebook. Note that it is constant modulus.

The codebooks specified for 5G NR are typically constant modulus and the codebooks that result from some embodiments presented herein can also (at least almost) achieve this property; e.g. by considering a cost function based on PAR as exemplified above.

Furthermore, it should be noted that some embodiments may be combined with hierarchical approaches for beam sweeping where an initial, coarse, beam sweep provides an initial estimate, or a relevant spatial region, to use for further, more refined, beam sweeping. Then, compression approaches as described herein may be applied for the further, more refined, beam sweeping, for example.

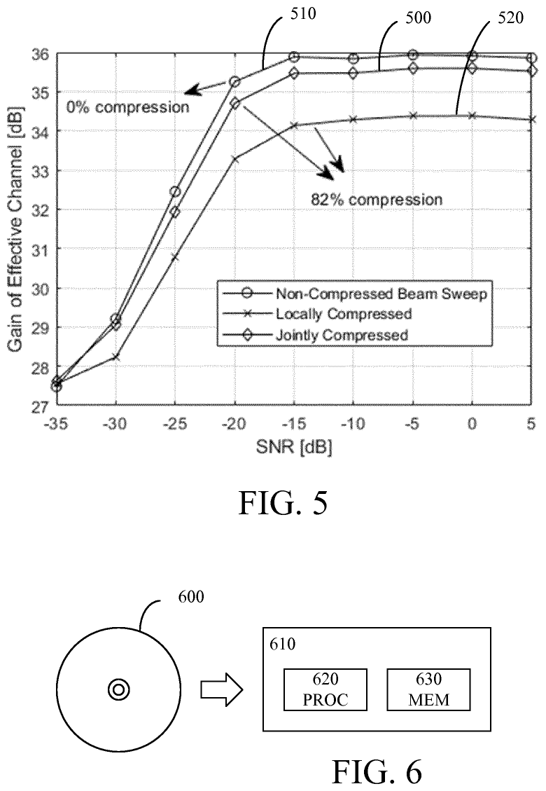

FIG. 5 is a simulation plot illustrating example results achievable by application of some embodiments in the context of multi-user MIMO beam sweeping in the UL; the two or more transmission arrangements are UE:s and the at least one receiver arrangement is a BS.

In analogy with the examples above, Hₖ represents an M×K UL narrowband MIMO channel (e.g., a MIMO channel on an OFDM subcarrier) for user k. For illustrative purposes, it is assumed that both the BS and UE:s employ uniform linear arrays (ULA:s); thus the narrowband MIMO channel can be expressed as

$${H}_{k} = {\sum }_{i = 1}^{P} {a}_{k}^{( i )} {e}_{BS} ( {θ}_{k}^{( i )} ) {{e}_{UE} ( {ϕ}_{k}^{( i )} )}^{T}$$

where e_{BS}(θ)=[1 e^{iπ sin(θ)} . . . e^{iπ(M-1) sin(θ)}]^{T}, e_{BS}(ϕ)=[1 e^{iπ sin(ϕ)} . . . e^{iπ(K-1) sin(ϕ)}]^{T}, aₖ⁽ⁱ⁾ are complex Gaussian scalars with unit variance and P is the number of simultaneously received channel paths, e.g., reflections. In a mmWave scenario, the number of channel paths P is small, typically P≤10. In an outdoor scenario with dominant line-of-sight, LOS, and ground reflection, we have P=2.

For the simulation results illustrated in FIG. 5, the beam vectors in Fₖ are uniformly spread analog beams in the azimuth direction (which is the typical DFT-like codebook for a mmWave channel). The simulations are done with M=128 BS antennas, K=16 antennas per UE, N=3 UE:s, and P=8 channel paths per UE.

FIG. 5 shows the performance for application of some embodiments, 500, compared with application of non-compression, 510, and the single-user compression, 520. The gain of the effective channel (i.e., the combination of the beamforming and the propagation channel) is measured as 10 log(∥Hₖ Fₖ(:, \hat{l}ₖ)∥²), where \hat{l}ₖ is the estimated index of the strongest beam for UE k. Since the channel model is symmetric between UE:s, the result may be evaluated in the context of one UE since the same performance applies for all UE:s.

The uppermost curve 510 corresponds to performance results achievable by the classical case when there is no compression is applied, i.e., each UE transmits one beam at a time from Fₖ, the BS listens on one beam at a time, and UE:s sound their beams in orthogonal resources. It may be is expected that this curve will, generally, have the best performance since it gets as much information as possible for beam selection; i.e., this curve may be sees as a benchmark for performance.

The lowermost curve 520 corresponds to performance results achievable when each UE independently compresses its own codebook, i.e., each UE uses a Grassmannian matrix for compression, and UE:s sounds their compressed beams in orthogonal resources. In this example, each of the UE:s only uses three resources to sound 16 beams; entailing a resource saving due to compression of 1-3/16=82%. As expected, there is a performance loss in the sense that the strongest beam will not always be selected.

The middle curve 550 corresponds to the performance results achievable when the UE:s jointly compress their codebooks as suggested herein, i.e., UE:s share the same resources for sounding and mitigate inter-user interference by encoding their beams in a joint fashion. For this case, there is also a resource saving due to compression of 1-3/16=82%. There is a performance loss compared to the benchmark in the sense that the strongest beam will not always be selected. However, the performance loss is much less pronounced than for 520.

Generally, when an arrangement is referred to herein, it is to be understood as a physical product; e.g., an apparatus. The physical product may comprise one or more parts, such as controlling circuitry in the form of one or more controllers, one or more processors, or the like.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a control node.

Embodiments may appear within an electronic apparatus (such as a control node) comprising arrangements, circuitry, and/or logic according to any of the embodiments described herein. Alternatively or additionally, an electronic apparatus (such as a control node node) may be configured to perform methods according to any of the embodiments described herein.

According to some embodiments, a computer program product comprises a computer readable medium such as, for example a universal serial bus (USB) memory, a plug-in card, an embedded drive or a read only memory (ROM). FIG. 6 illustrates an example computer readable medium in the form of a compact disc (CD) ROM 600. The computer readable medium has stored thereon a computer program comprising program instructions. The computer program is loadable into a data processor (PROC; e.g., data processing circuitry or a data processing unit) 620, which may, for example, be comprised in a wireless communication device or a network node 610. When loaded into the data processor, the computer program may be stored in a memory (MEM) 630 associated with or comprised in the data-processing unit. According to some embodiments, the computer program may, when loaded into and run by the data processing unit, cause execution of method steps according to, for example, any of the methods illustrated in FIGS. 1 and 2 or otherwise described herein.

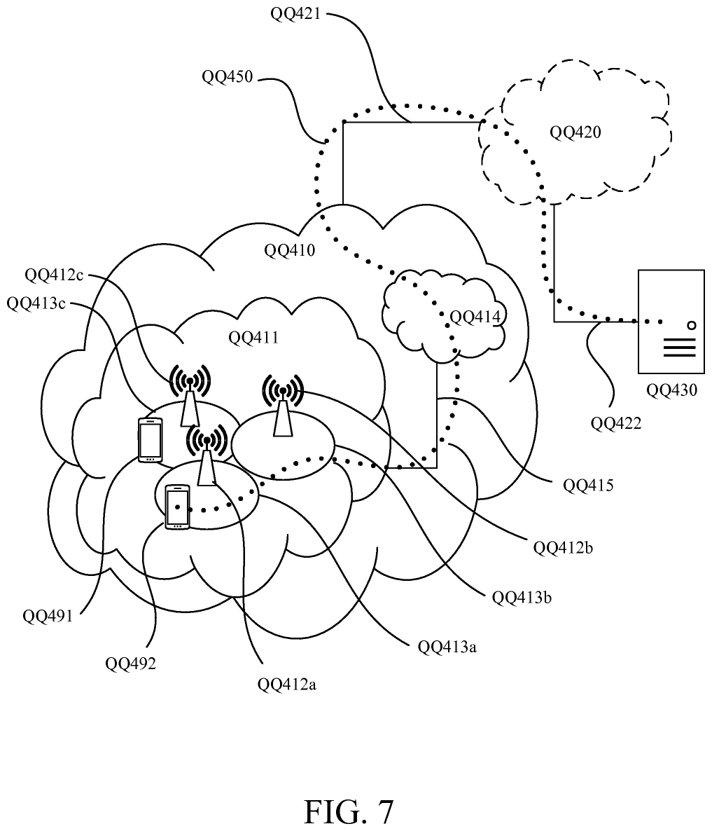

With reference to FIG. 7, in accordance with an embodiment, a communication system includes telecommunication network QQ410, such as a 3GPP-type cellular network, which comprises access network QQ411, such as a radio access network, and core network QQ414. Access network QQ411 comprises a plurality of base stations QQ412a, QQ412b, QQ412c, such as NBs, eNBs, gNBs or other types of wireless access points, each defining a corresponding coverage area QQ413a, QQ413b, QQ413c. Each base station QQ412a, QQ412b, QQ412c is connectable to core network QQ414 over a wired or wireless connection QQ415. A first UE QQ491 located in coverage area QQ413c is configured to wirelessly connect to, or be paged by, the corresponding base station QQ412c. A second UE QQ492 in coverage area QQ413a is wirelessly connectable to the corresponding base station QQ412a. While a plurality of UEs QQ491, QQ492 are illustrated in this example, the disclosed embodiments are equally applicable to a situation where a sole UE is in the coverage area or where a sole UE is connecting to the corresponding base station QQ412.

Telecommunication network QQ410 is itself connected to host computer QQ430, which may be embodied in the hardware and/or software of a standalone server, a cloud-implemented server, a distributed server or as processing resources in a server farm. Host computer QQ430 may be under the ownership or control of a service provider, or may be operated by the service provider or on behalf of the service provider. Connections QQ421 and QQ422 between telecommunication network QQ410 and host computer QQ430 may extend directly from core network QQ414 to host computer QQ430 or may go via an optional intermediate network QQ420. Intermediate network QQ420 may be one of, or a combination of more than one of, a public, private or hosted network; intermediate network QQ420, if any, may be a backbone network or the Internet; in particular, intermediate network QQ420 may comprise two or more sub-networks (not shown).

The communication system of FIG. 7 as a whole enables connectivity between the connected UEs QQ491, QQ492 and host computer QQ430. The connectivity may be described as an over-the-top (OTT) connection QQ450. Host computer QQ430 and the connected UEs QQ491, QQ492 are configured to communicate data and/or signaling via OTT connection QQ450, using access network QQ411, core network QQ414, any intermediate network QQ420 and possible further infrastructure (not shown) as intermediaries. OTT connection QQ450 may be transparent in the sense that the participating communication devices through which OTT connection QQ450 passes are unaware of routing of uplink and downlink communications. For example, base station QQ412 may not or need not be informed about the past routing of an incoming downlink communication with data originating from host computer QQ430 to be forwarded (e.g., handed over) to a connected UE QQ491. Similarly, base station QQ412 need not be aware of the future routing of an outgoing uplink communication originating from the UE QQ491 towards the host computer QQ430.

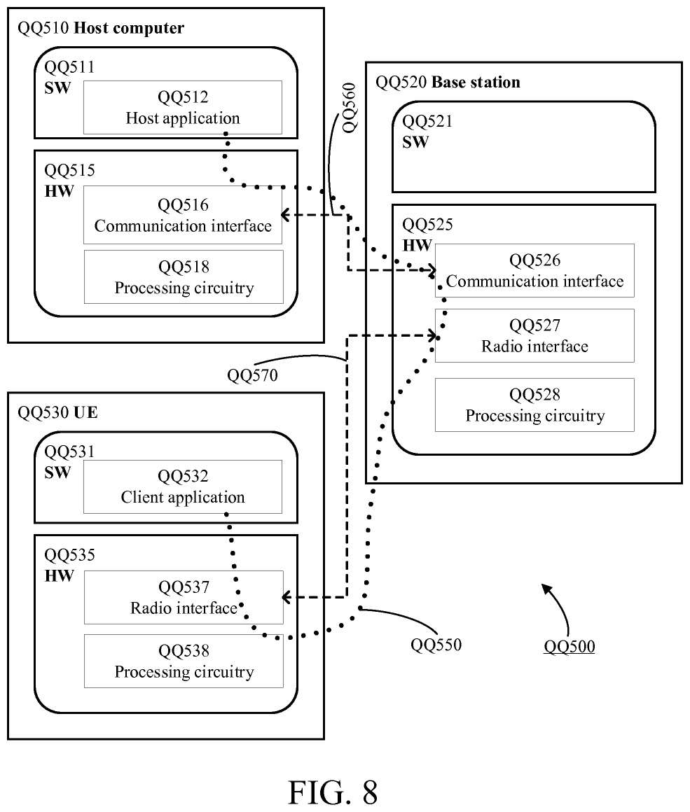

Example implementations, in accordance with an embodiment, of the UE, base station and host computer discussed in the preceding paragraphs will now be described with reference to FIG. 8. In communication system QQ500, host computer QQ510 comprises hardware QQ515 including communication interface QQ516 configured to set up and maintain a wired or wireless connection with an interface of a different communication device of communication system QQ500. Host computer QQ510 further comprises processing circuitry QQ518, which may have storage and/or processing capabilities. In particular, processing circuitry QQ518 may comprise one or more programmable processors, application-specific integrated circuits, field programmable gate arrays or combinations of these (not shown) adapted to execute instructions. Host computer QQ510 further comprises software QQ511, which is stored in or accessible by host computer QQ510 and executable by processing circuitry QQ518. Software QQ511 includes host application QQ512. Host application QQ512 may be operable to provide a service to a remote user, such as UE QQ530 connecting via OTT connection QQ550 terminating at UE QQ530 and host computer QQ510. In providing the service to the remote user, host application QQ512 may provide user data which is transmitted using OTT connection QQ550.

Communication system QQ500 further includes base station QQ520 provided in a telecommunication system and comprising hardware QQ525 enabling it to communicate with host computer QQ510 and with UE QQ530. Hardware QQ525 may include communication interface QQ526 for setting up and maintaining a wired or wireless connection with an interface of a different communication device of communication system QQ500, as well as radio interface QQ527 for setting up and maintaining at least wireless connection QQ570 with UE QQ530 located in a coverage area (not shown in FIG. 8) served by base station QQ520. Communication interface QQ526 may be configured to facilitate connection QQ560 to host computer QQ510. Connection QQ560 may be direct or it may pass through a core network (not shown in FIG. 8) of the telecommunication system and/or through one or more intermediate networks outside the telecommunication system. In the embodiment shown, hardware QQ525 of base station QQ520 further includes processing circuitry QQ528, which may comprise one or more programmable processors, application-specific integrated circuits, field programmable gate arrays or combinations of these (not shown) adapted to execute instructions. Base station QQ520 further has software QQ521 stored internally or accessible via an external connection.

Communication system QQ500 further includes UE QQ530 already referred to. Its hardware QQ535 may include radio interface QQ537 configured to set up and maintain wireless connection QQ570 with a base station serving a coverage area in which UE QQ530 is currently located. Hardware QQ535 of UE QQ530 further includes processing circuitry QQ538, which may comprise one or more programmable processors, application-specific integrated circuits, field programmable gate arrays or combinations of these (not shown) adapted to execute instructions. UE QQ530 further comprises software QQ531, which is stored in or accessible by UE QQ530 and executable by processing circuitry QQ538. Software QQ531 includes client application QQ532. Client application QQ532 may be operable to provide a service to a human or non-human user via UE QQ530, with the support of host computer QQ510. In host computer QQ510, an executing host application QQ512 may communicate with the executing client application QQ532 via OTT connection QQ550 terminating at UE QQ530 and host computer QQ510. In providing the service to the user, client application QQ532 may receive request data from host application QQ512 and provide user data in response to the request data. OTT connection QQ550 may transfer both the request data and the user data. Client application QQ532 may interact with the user to generate the user data that it provides.

It is noted that host computer QQ510, base station QQ520 and UE QQ530 illustrated in FIG. 8 may be similar or identical to host computer QQ430, one of base stations QQ412a, QQ412b, QQ412c and one of UEs QQ491, QQ492 of FIG. 7, respectively. This is to say, the inner workings of these entities may be as shown in FIG. 8 and independently, the surrounding network topology may be that of FIG. 7.

In FIG. 8, OTT connection QQ550 has been drawn abstractly to illustrate the communication between host computer QQ510 and UE QQ530 via base station QQ520, without explicit reference to any intermediary devices and the precise routing of messages via these devices. Network infrastructure may determine the routing, which it may be configured to hide from UE QQ530 or from the service provider operating host computer QQ510, or both. While OTT connection QQ550 is active, the network infrastructure may further take decisions by which it dynamically changes the routing (e.g., on the basis of load balancing consideration or reconfiguration of the network).

Wireless connection QQ570 between UE QQ530 and base station QQ520 is in accordance with the teachings of the embodiments described throughout this disclosure. One or more of the various embodiments improve the performance of OTT services provided to UE QQ530 using OTT connection QQ550, in which wireless connection QQ570 forms the last segment. More precisely, the teachings of these embodiments may require less resource allocation and/or less signaling overhead and thereby provide benefits such as improve the efficiency of beam measurements (e.g., beam evaluation and/or beam selection).

A measurement procedure may be provided for the purpose of monitoring data rate, latency and other factors on which the one or more embodiments improve. There may further be an optional network functionality for reconfiguring OTT connection QQ550 between host computer QQ510 and UE QQ530, in response to variations in the measurement results. The measurement procedure and/or the network functionality for reconfiguring OTT connection QQ550 may be implemented in software QQ511 and hardware QQ515 of host computer QQ510 or in software QQ531 and hardware QQ535 of UE QQ530, or both. In embodiments, sensors (not shown) may be deployed in or in association with communication devices through which OTT connection QQ550 passes; the sensors may participate in the measurement procedure by supplying values of the monitored quantities exemplified above, or supplying values of other physical quantities from which software QQ511, QQ531 may compute or estimate the monitored quantities. The reconfiguring of OTT connection QQ550 may include message format, retransmission settings, preferred routing etc.; the reconfiguring need not affect base station QQ520, and it may be unknown or imperceptible to base station QQ520. Such procedures and functionalities may be known and practiced in the art. In certain embodiments, measurements may involve proprietary UE signaling facilitating host computer QQ510's measurements of throughput, propagation times, latency and the like. The measurements may be implemented in that software QQ511 and QQ531 causes messages to be transmitted, in particular empty or ‘dummy’ messages, using OTT connection QQ550 while it monitors propagation times, errors etc.

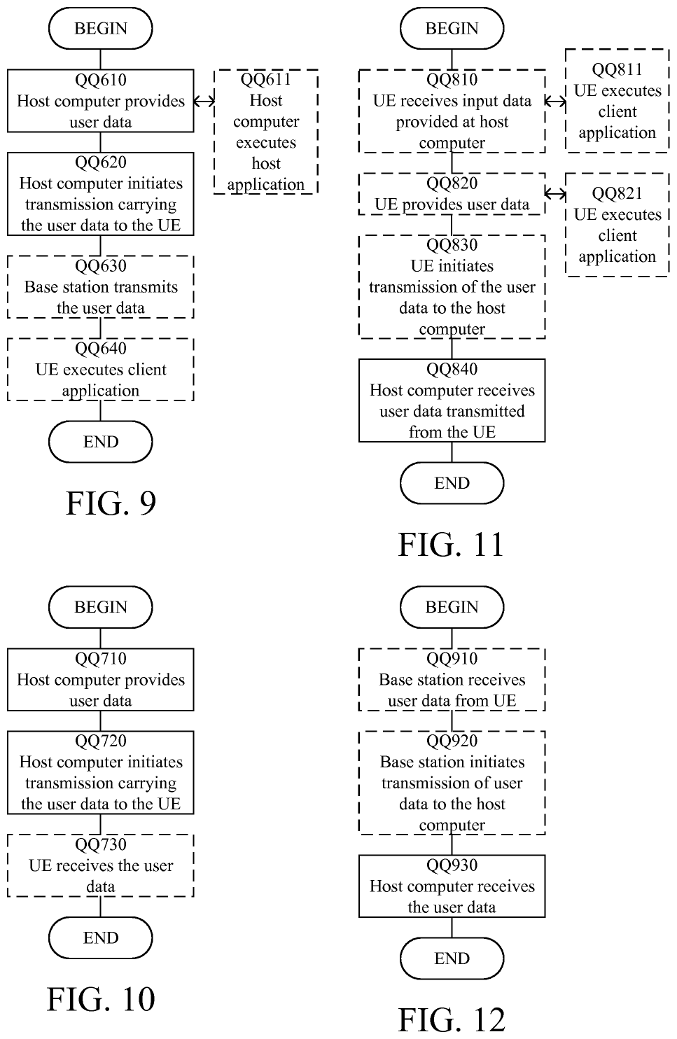

FIG. 9 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 9 will be included in this section. In step QQ610, the host computer provides user data. In substep QQ611 (which may be optional) of step QQ610, the host computer provides the user data by executing a host application. In step QQ620, the host computer initiates a transmission carrying the user data to the UE. In step QQ630 (which may be optional), the base station transmits to the UE the user data which was carried in the transmission that the host computer initiated, in accordance with the teachings of the embodiments described throughout this disclosure. In step QQ640 (which may also be optional), the UE executes a client application associated with the host application executed by the host computer.

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section. In step QQ710 of the method, the host computer provides user data. In an optional substep (not shown) the host computer provides the user data by executing a host application. In step QQ720, the host computer initiates a transmission carrying the user data to the UE. The transmission may pass via the base station, in accordance with the teachings of the embodiments described throughout this disclosure. In step QQ730 (which may be optional), the UE receives the user data carried in the transmission.

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section. In step QQ810 (which may be optional), the UE receives input data provided by the host computer. Additionally or alternatively, in step QQ820, the UE provides user data. In substep QQ821 (which may be optional) of step QQ820, the UE provides the user data by executing a client application. In substep QQ811 (which may be optional) of step QQ810, the UE executes a client application which provides the user data in reaction to the received input data provided by the host computer. In providing the user data, the executed client application may further consider user input received from the user. Regardless of the specific manner in which the user data was provided, the UE initiates, in substep QQ830 (which may be optional), transmission of the user data to the host computer. In step QQ840 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 12 will be included in this section. In step QQ910 (which may be optional), in accordance with the teachings of the embodiments described throughout this disclosure, the base station receives user data from the UE. In step QQ920 (which may be optional), the base station initiates transmission of the received user data to the host computer. In step QQ930 (which may be optional), the host computer receives the user data carried in the transmission initiated by the base station.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

### Example Embodiments

### Group A Embodiments

A1. A method performed by a wireless device for beam measurements, the wireless device acting as a control node of a wireless communication system, wherein the wireless communication system comprises two or more transmission arrangements and a receiver arrangement, and wherein each transmission arrangement is associated with a respective set of available beams for beam measurements, the method comprising:
   determining, for at least one transmission arrangement of the two or more transmission arrangements, a respective collection of linear combinations of available beams, wherein at least one of the linear combinations comprises available beams from at least two sets of available beams associated with different transmission arrangements of the two or more transmission arrangements; and
   causing transmission, by the transmission arrangements, of at least one of the linear combinations of available beams for beam measurements by the receiver arrangement.
A2. The method of any of the previous embodiments in Group A, further comprising:
   providing user data; and
   forwarding the user data to a host computer via the transmission to the base station.

### Group B Embodiments

B1. A method performed by a base station for beam measurements, the base station acting as a control node of a wireless communication system, wherein the wireless communication system comprises two or more transmission arrangements and a receiver arrangement, and wherein each transmission arrangement is associated with a respective set of available beams for beam measurements, the method comprising:
   determining, for at least one transmission arrangement of the two or more transmission arrangements, a respective collection of linear combinations of available beams, wherein at least one of the linear combinations comprises available beams from at least two sets of available beams associated with different transmission arrangements of the two or more transmission arrangements; and
   causing transmission, by the transmission arrangements, of at least one of the linear combinations of available beams for beam measurements by the receiver arrangement.
B2. The method of any of the previous embodiments in Group B, further comprising:
   obtaining user data; and
   forwarding the user data to a host computer or a wireless device.

### Group C Embodiments

C1. A wireless device for beam measurements, the wireless device comprising:
   processing circuitry configured to perform any of the steps of any of the Group A embodiments; and
   power supply circuitry configured to supply power to the wireless device.
C2. A base station for beam measurements, the base station comprising:
   processing circuitry configured to perform any of the steps of any of the Group B embodiments;
   power supply circuitry configured to supply power to the base station.
C3. A user equipment (UE) for beam measurements, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.

### Group D Embodiments

D1. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps described for the Group B embodiments.
D2. The communication system of embodiment D1 further including the base station.
D3. The communication system of any of embodiments D1 through D2, further including the UE, wherein the UE is configured to communicate with the base station.
D4. The communication system of any of embodiments D1 through D3, wherein:
   the processing circuitry of the host computer is configured to execute a host application, thereby providing the user data; and
   the UE comprises processing circuitry configured to execute a client application associated with the host application.
D5. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps described for the Group B embodiments.
D6. The method of embodiment D5, further comprising, at the base station, transmitting the user data.
D7. The method of any of embodiments D5 through D6, wherein the user data is provided at the host computer by executing a host application, the method further comprising, at the UE, executing a client application associated with the host application.
D8. A user equipment (UE) configured to communicate with a base station, the UE comprising a radio interface and processing circuitry configured to perform the method of any of embodiments D5 through D7.
D9. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps described for the Group A embodiments.
D10. The communication system of embodiment D9, wherein the cellular network further includes a base station configured to communicate with the UE.
D11. The communication system of any of embodiments D9 through D10, wherein:
   the processing circuitry of the host computer is configured to execute a host application, thereby providing the user data; and
   the UE's processing circuitry is configured to execute a client application associated with the host application.
D12. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps described for the Group A embodiments.
D13. The method of embodiment D12, further comprising at the UE, receiving the user data from the base station.
D14. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps described for the Group A embodiments.
D15. The communication system of embodiment D14, further including the UE.
D16. The communication system of any of embodiments D14 through D15, further including the base station, wherein the base station comprises a radio interface configured to communicate with the UE and a communication interface configured to forward to the host computer the user data carried by a transmission from the UE to the base station.
D17. The communication system of any of embodiments D14 through D16, wherein:
   the processing circuitry of the host computer is configured to execute a host application; and
   the UE's processing circuitry is configured to execute a client application associated with the host application, thereby providing the user data.
D18. The communication system of any of embodiments D14 through D17, wherein:
   the processing circuitry of the host computer is configured to execute a host application, thereby providing request data; and
   the UE's processing circuitry is configured to execute a client application associated with the host application, thereby providing the user data in response to the request data.
D19. A method implemented in a communication system including a host computer, a base station and a user equipment (UE), the method comprising:
   at the host computer, receiving user data transmitted to the base station from the UE, wherein the UE performs any of the steps described for the Group A embodiments.
D20. The method of embodiment D19, further comprising, at the UE, providing the user data to the base station.
D21. The method of any of embodiments D19 through D20, further comprising:
   at the UE, executing a client application, thereby providing the user data to be transmitted; and
   at the host computer, executing a host application associated with the client application.
D22. The method of any of embodiments D19 through D21, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
D23. A user equipment (UE) configured to communicate with a base station, the UE comprising a radio interface and processing circuitry configured to perform the method of any of embodiments D19 through D22.
D24. A communication system including a host computer comprising a communication interface configured to receive user data originating from a transmission from a user equipment (UE) to a base station, wherein the base station comprises a radio interface and processing circuitry, the base station's processing circuitry configured to perform any of the steps described for the Group B embodiments.
D25. The communication system of embodiment D24 further including the base station.
D26. The communication system of any of embodiments D24 through D25, further including the UE, wherein the UE is configured to communicate with the base station.
D27. The communication system of any of embodiments D24 through D25, wherein:
   the processing circuitry of the host computer is configured to execute a host application;
   the UE is configured to execute a client application associated with the host application, thereby providing the user data to be received by the host computer.
D28. A method implemented in a communication system including a host computer, a base station and a user equipment (UE), the method comprising:
   at the host computer, receiving, from the base station, user data originating from a transmission which the base station has received from the UE, wherein the UE performs any of the steps described for the Group A embodiments.
D29. The method of embodiment D28, further comprising at the base station, receiving the user data from the UE.
D30. The method of any of embodiments D28 through D29, further comprising at the base station, initiating a transmission of the received user data to the host computer.
D31. A method implemented in a communication system including a host computer, a base station and a user equipment (UE), the method comprising:
   at the host computer, receiving, from the base station, user data originating from a transmission which the base station has received from the UE, wherein the base station performs any of the steps described for the Group B embodiments.
D32. The method of embodiment D31, further comprising at the base station, receiving the user data from the UE.
D33. The method of any of embodiments D31 through D32, further comprising at the base station, initiating a transmission of the received user data to the host computer.

1. A method for a control node of a wireless communication system, wherein the wireless communication system comprises two or more transmission arrangements and a receiver arrangement, wherein each transmission arrangement is associated with a respective set of available beams for beam measurements, the method comprising:
determining, for at least one transmission arrangement of the two or more transmission arrangements, a respective collection of linear combinations of available beams, wherein at least one of the linear combinations comprises available beams from at least two sets of available beams associated with different transmission arrangements of the two or more transmission arrangements; and
causing transmission, by the transmission arrangements, of at least one of the linear combinations of available beams for beam measurements by the receiver arrangement.

2. The method of claim 1, wherein causing transmission comprises transmitting one or more of the available beams of the at least one linear combination.

3. The method of claim 1, wherein causing transmission comprises providing an indication of the respective collection of linear combinations of available beams to the transmission arrangements.

4. The method of claim 1, wherein determining the respective collection of linear combinations of available beams for at least one transmission arrangement comprises determining a respective collection of linear combinations of available beams for each transmission arrangement.

5. The method of claim 1, wherein a cardinality of the respective collection of linear combinations of available beams for a transmission arrangement is lower than an accumulated cardinality, for all of the transmission arrangements, of the respective sets of available beams.

6. The method of claim 1, wherein determining the respective collection of linear combinations of available beams is based on one or more of:
a sparsity of a channel between the two or more transmission arrangements and the receiver arrangement; and
properties of a compression matrix representing the respective collections of linear combinations of available beams for all of the two or more transmission arrangements.

7. The method of claim 1, wherein the respective collection of linear combinations of available beams is defined by an exclusive part of a Grassmannian coding matrix.

8. The method of claim 1, wherein respective collections of linear combinations of available beams for the two or more transmission arrangements, each respective collection representable by a matrix Bₖ, are determined such that A^{H} A is a substantially block diagonal matrix, wherein A=B ⊗I, B=[B₁ . . . B_{K} . . . B_{K}], and ⊗ represents Kronecker product.

9. The method of claim 1, wherein causing transmission, by the transmission arrangements, of at least one of the linear combinations of available beams comprises causing one or more of:
transmission of the linear combinations of available beams in respective transmission time resources, at least some of the respective time resources being different; and
transmission of the linear combinations of available beams in respective transmission frequency resources, at least some of the respective frequency resources being different.

10. The method of claim 9, wherein causing transmission of at least one of the linear combinations of available beams of one of the two or more transmission arrangements comprises causing the transmission in a transmission resource which is also used for transmission, by another one of the two or more transmission arrangements, of a linear combination of its respective collection.

11. The method of claim 1, wherein the method is applied, for at least one of the transmission arrangements, during a training phase for beam selection and/or for beam evaluation.

12. The method of claim 1, further comprising:
receiving a beam measurement report from the receiver arrangement; and
selecting a beam for communication based on the received beam measurement report.

13. The method of claim 1, wherein determining the respective collection of linear combinations of available beams for at least one transmission arrangement further comprises estimating a value of a cost function based on the determined respective collection of linear combinations of available beams, and wherein determining is iteratively repeated until a cost function condition is met.

14. A non-transitory computer readable medium, having thereon a computer program comprising program instructions, the computer program being loadable into a data processing unit and configured to cause execution of a method when the computer program is run by the data processing unit, wherein the method is for a control node of a wireless communication system, wherein the wireless communication system comprises two or more transmission arrangements and a receiver arrangement, wherein each transmission arrangement is associated with a respective set of available beams for beam measurements, and wherein the method comprises:
determining, for at least one transmission arrangement of the two or more transmission arrangements, a respective collection of linear combinations of available beams, wherein at least one of the linear combinations comprises available beams from at least two sets of available beams associated with different transmission arrangements of the two or more transmission arrangements; and
causing transmission, by the transmission arrangements, of at least one of the linear combinations of available beams for beam measurements by the receiver arrangement.

15. An apparatus for a control node of a wireless communication system, wherein the wireless communication system comprises two or more transmission arrangements and a receiver arrangement, wherein each transmission arrangement is associated with a respective set of available beams for beam measurements, the apparatus comprising controlling circuitry configured to cause:
determination, for at least one transmission arrangement of the two or more transmission arrangements, of a respective collection of linear combinations of available beams, wherein at least one of the linear combinations comprises available beams from at least two sets of available beams associated with different transmission arrangements of the two or more transmission arrangements; and
transmission, by the transmission arrangements, of at least one of the linear combinations of available beams for beam measurements by the receiver arrangement.

16. The apparatus of claim 15, wherein causing transmission comprises causing transmission, by a transmission arrangement comprised in the control node, of one or more of the available beams of the at least one linear combination.

17-27. (canceled)

28. A control node comprising the apparatus of claim 15.

29. The control node of claim 28, wherein the control node further comprises one or more of the two or more transmission arrangements and/or a receiver arrangement.

30. A user equipment comprising the apparatus of claim 15.

31. The UE of claim 30, wherein the UE further comprises one or more of the two or more transmission arrangements and/or a receiver arrangement.
